(19) United States
(12) Patent Application Publication
(10) Pub. No.: US 2026/0239065 A1
(43) Pub. Date: Aug. 13, 2026

(54) GROUP BASED REPORTING OF UE RELATED INFORMATION

(71) Applicant: Telefonaktiebolaget LM Ericsson (publ), Stockholm (SE)

(72) Inventors: Serban PURGE, Issy-les-Moulineaux (FR); Luca LUNARDI, Genova (IT); Angelo CENTONZA, Granada (ES); Ioanna PAPPA, Stockholm (SE); Julien MULLER, Rennes (FR)

(73) Assignee: Telefonaktiebolaget LM Ericsson (publ), Stockholm (SE)

(21) Appl. No.: 19/147,861

(22) PCT Filed: Jan. 12, 2024
(86) PCT No.: PCT/EP2024/050695

§ 371 Date: Jul. 14, 2025

(30) Foreign Application Priority Data
Jan. 16, 2023 (GR) 20230100027

(51) Int. Cl. H04W 24/10; H04L 43/0811; H04W 36/00

(52) U.S. Cl. CPC H04W 24/10; H04L 43/0811; H04W 36/0072

(57) ABSTRACT

A method performed by a first network node. The method comprising transmitting towards a second network node a request message for requesting first user equipment, UE, related information. Wherein the request message includes a first group UE identifier, ID, identifying a first group of one or more UEs for which the first UE related information is requested. The method further comprises, after transmitting the request message, receiving a reporting message which includes first UE related information for one or more UEs included in the first group of UEs. Wherein the reporting message includes one or more performance measurement results and one or more series IDs each of which identifies a UE associated with each of the one or more measurement results, and the reporting message was transmitted by the second network node.

### TECHNICAL FIELD

This disclosure relates to group based reporting of UE related information.

### BACKGROUND

A next generation (NG) radio access network (RAN) consists of a set of new generation radio base stations (gNBs) connected to the 5G Core (5GC) through the NG interface. As specified in 3GPP Technical Specification (TS) 38.300, e.g. v17.2.0, NG-RAN could also consist of a set of ng-Evolved Node B/E-UTRAN Node B (eNBs), an ng-eNB may consist of an ng-eNB-central unit (CU) and one or more ng-eNB-distribution unit(s) (DU(s)). The ng-eNB-CU and the ng-eNB-DU is connected via W1 interface. The general principle described in this section also applies to ng-eNB and W1 interface, if not explicitly specified otherwise.

An gNB can support Frequency Division Duplex (FDD) mode, Time Division Duplex (TDD) mode, or dual mode operation. gNBs can be interconnected through the Xn interface. A gNB may consist of a gNB-CU and one or more gNB-DU(s). A gNB-CU and a gNB-DU is connected via F1 interface. One gNB-DU is connected to only one gNB-CU.

In case of network sharing with multiple cell ID broadcast, each Cell Identity associated with a subset of Public Land Mobile Networks (PLMNs) corresponds to a gNB-DU and the gNB-CU it is connected to, i.e. the corresponding gNB-DUs share the same physical layer cell resources. For resiliency, a gNB-DU may be connected to multiple gNB-CUs by appropriate implementation. NG, Xn and F1 are logical interfaces.

For NG-RAN, the NG and Xn-C interfaces for a gNB consisting of a gNB-CU and gNB-DUs, terminate in the gNB-CU. For E-UTRAN-NR (EN)-Dual Connectivity (DC), the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The node hosting user plane part of New Radio (NR) Packet Data Convergence Protocol (PDCP) (e.g. gNB-CU, gNB central unit user plane (CU-UP), and for E-UTRA-NR Dual Connectivity (EN-DC), master eNodeb (MeNB) or secondary gNodeb (SgNB) depending on the bearer split) shall perform user inactivity monitoring and further informs its inactivity or (re)activation to the node having control plane (CP) connection towards the core network (e.g. over E1, X2). The node hosting NR Radio Link Control (RLC) (e.g. gNB-DU) may perform user inactivity monitoring and further inform its inactivity or (re)activation to the node hosting control plane, e.g. gNB-CU or gNB-CU-CP.

UL Packet Data Convergence Protocol (PDCP) configuration (i.e. how the UE uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN) and F1-U.

The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport, signalling transport.

In NG-Flex configuration, each NG-RAN node is connected to all Access and Mobility Management Functions (AMFs) of AMF Sets within an AMF Region supporting at least one slice also supported by the NG-RAN node. The AMF Set and the AMF Region are defined in 3GPP TS 23.501, e.g. v18.0.0. If security protection for control plane and user plane data on TNL of NG-RAN interfaces has to be supported, NDS/IP 3GPP TS 33.501, e.g. v18.0.0, shall be applied.

The overall architecture for separation of gNB-CU-CP and gNB-CU-UP is specified in TS 37.483, e.g. v17.3.0, and described below. A gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP. One gNB-CU-UP can be connected to multiple DUs under the control of the same gNB-CU-CP.

The connectivity between a gNB-CU-UP and a gNB-DU is established by the gNB-CU-CP using Bearer Context Management functions. The gNB-CU-CP selects the appropriate gNB-CU-UP(s) for the requested services for the UE. In case of multiple CU-UPs they belong to same security domain as defined in TS 33.210, e.g. v17.1.0. Data forwarding between gNB-CU-UPs during intra-gNB-CU-CP handover within a gNB may be supported by Xn-U.

As described below, NG-RAN node 1, which hosts the Model Inference, requires feedback related to the Network Energy Saving, Load Balancing, or Mobility Optimization action taken by NG-RAN node 1 from NG-RAN node 2, which is any neighbouring NG-RAN node of NG-RAN node 1.

Section 5.1.2.6, Section 5.2.2.6, and Section 5.3.2.6 in TR 37.817, e.g. v17.0.0, list the type of feedback given for Artificial Intelligence (AI)/Machine Learning (ML)-based Network Energy Saving, Load Balancing, and Mobility Optimization. In one example, the action taken by NG-RAN node 1 (serving NG-RAN node) entails a handover of at least one UE to NG-RAN node 2 (target NG-RAN node). In this example, the feedback includes UE performance (e.g., of handed-over UEs), affected by the action, including Quality of Service (QoS) parameters such throughput/bitrate, packet delay/latency, packet loss, etc.

FIG. 6 illustrates a process according to FIG. 5.1.2.2-1.1 from TR 37.817 Model Training and Model Inference at NG-RAN. In FIG. 6 the NG-RAN is responsible for model training and generates energy saving decisions. The process of FIG. 6 begins with Step 0.

Step 0: NG-RAN node 2 is assumed to have an AI/ML model optionally, which can provide NG-RAN node 1 with input information.
Step 1: NG-RAN node 1 configures the measurement information on the UE side and sends configuration message to UE to perform measurement procedure and reporting.
Step 2: The UE collects the indicated measurement(s), e.g., UE measurements related to RSRP, RSRQ, SINR of serving cell and neighbouring cells.
Step 3: The UE sends the measurement report(s) to NG-RAN node 1 including the required measurement result.
Step 4: NG-RAN node 2 sends the required input data to NG-RAN node 1 for model training of AI/ML-based network energy saving.
Step 5: NG-RAN node 1 trains AI/ML model for AI/ML-based energy saving based on collected data. NG-RAN node 2 is assumed to have AI/ML model for AI/ML-based energy saving optionally, which can also generate predicted results/actions.
Step 6: NG-RAN node 2 sends the required input data to NG-RAN node 1 for model inference of AI/ML-based network energy saving.
Step 7: UE sends the UE measurement report(s) to NG-RAN node 1.
Step 8: Based on local inputs of NG-RAN node 1 and received inputs from NG-RAN node 2, NG-RAN node 1 generates model inference output (e.g., energy saving strategy, handover strategy, etc).
Step 9: NG-RAN node 1 executes Network energy saving actions according to the model inference output. NG-RAN node 1 may select the most appropriate target cell for each UE before it performs handover, if the output is handover.

To optimize the performance of an AI/ML-based network energy saving model, the following feedback can be considered to be collected from NG-RAN nodes:
Resource status of neighboring NG-RAN node/s;
Energy efficiency;
UE performance affected by the energy saving action (e.g., handed-over UEs), including bitrate, packet loss and latency;
UE performance affected by the energy saving action (e.g., handed-over UEs), including bitrate, packet loss and latency; and/or
System KPIs (e.g., throughput, delay, RLF of current and neighboring NG-RAN node/s). See Section 5.1.2.6 of TR 37.817 for the Network Energy Saving use case Section 5.2.2.3 of TR 37.817 for the Load Balancing use case states:

A high-level signalling flow for the AI/ML use case related to Load Balancing with Model Training and Model Inference in a NG-RAN node is shown in FIG. 7 below.

FIG. 7 illustrates a process according to FIG. 5.2.2-2. Model Training and Model Inference in a NG-RAN node. The process of FIG. 7 begins with Step 0.
Step 0: NG-RAN node 2 is assumed to have an AI/ML model optionally, which can provide NG-RAN node 1 with useful input information, such as predicted resource status, etc.
Step 1: The NG-RAN node 1 configures UE to provide measurements and/or location information (e.g., RRM measurements, MDT measurements, velocity, position).
Step 2: The UE collects the indicated measurement(s), e.g., UE measurements related to RSRP, RSRQ, SINR of the serving cell and neighbouring cells.
Step 3: The UE reports to NG-RAN node 1 the requested measurements and/or location information (e.g., UE measurements related to RSRP, RSRQ, SINR of serving cell and neighbouring cells, velocity, position).
Step 4: The NG-RAN node 1 receives from the neighbouring NG-RAN node 2 the input information for load balancing model training.
Step 5: An AI/ML Model Training is located at NG-RAN node 1. The required measurements and input data from other NG-RAN nodes are leveraged to train the AI/ML model.
Step 6: NG-RAN node 1 receives UE measurements and/or location information.
Step 7: NG-RAN node 1 can receive from the neighbouring NG-RAN node 2 the input information for load balancing model inference.
Step 8: NG-RAN node 1 performs model inference and generate Load Balancing predictions or decisions.
Step 9: NG-RAN node 1 may take Load Balancing actions and the UE is moved from NG-RAN node 1 to NG-RAN node 2.
Step 10: NG-RAN node 2 sends feedback information to NG-RAN node 1 (e.g., resource status updates after load balancing, etc).

### Feedback of AI/ML-Based Load Balancing.

To optimize the performance of an AI/ML-based load balancing model, the following feedback can be considered to be collected from NG-RAN nodes:
UE performance information from target NG-RAN node (for those UEs handed over from source NG-RAN node);
Resource status information updates from target NG-RAN node; and
System KPIs (e.g., throughput, delay, RLF of current and neighboring NG-RAN node/s). See Section 5.2.2.6 of TR 37.817 for the Load Balancing use case.

Section 5.3.2.3 of TR 37.817 or the Mobility Optimization use case states:

AI/ML Model Training and AI/ML Model Inference in a NG-RAN node.

FIG. 8 illustrates a process according to FIG. 5.3.2.3-1. Model Training and Model Inference both located in RAN node). The process of FIG. 8 begins with Step 0.
Step 0. NG-RAN node 2 is assumed to optionally have an AI/ML model, which can generate required input such as resource status and utilization prediction/estimation etc.
Step 1. NG-RAN node1 configures the measurement information on the UE side and sends configuration message to UE including configuration information.
Step 2. UE collects the indicated measurement, e.g., UE measurements related to RSRP, RSRQ, SINR of serving cell and neighbouring cells.
Step 3. UE sends measurement report message to NG-RAN node1 including the required measurement.
Step 4. The NG-RAN node 1 obtains the input data for training from the NG-RAN node2, where the input data for training includes the required input information from the NG-RAN node 2. If the NG-RAN node 2 executes the AI/ML model, the input data for training can include the corresponding inference result from the NG-RAN node 2.
Step 5. Model training. Required measurements are leveraged to training AI/ML model for mobility optimization.
Step 6. NG-RAN node1 obtains the measurement report as inference data for real-time UE mobility optimization.
Step 7. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.
Step 8. Model Inference. Required measurements are leveraged into Model Inference to output the prediction, including e.g., UE trajectory prediction, target cell prediction, target NG-RAN node prediction, etc.
Step 9: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.
Step 10. The NG-RAN node 2 sends feedback information after mobility optimization action to the NG-RAN node 1.

UE mobility information for training purposes is only sent to gNBs that requested such information or when triggered.

Feedback of AI/ML-based Mobility Optimization.

To optimize the performance of an AI/ML-based mobility optimization model, the following data is required as feedback data:
QoS parameters such as throughput, packet delay, etc. of handed-over UE;
Resource status information updates from target NG-RAN node; and
Performance information from target NG-RAN node. See Section 5.3.2.6 of TR 37.817 for the Mobility Optimization use case.

The details of the performance information are to be discussed during normative work phase. See id.

As stated above, TR 37.817 also studies the case where the AI/ML Model Training is located in the OAM (Operations, Administration and Maintenance function) and the AI/ML Model Inference is located at NG-RAN (i.e., gNB). In this case, the feedback is signaled from both NG-RAN node 1 and the NG-RAN node 2 to the OAM but is the same as described above.

TR 37.817 also mentions the use of so-called “Model Performance Feedback”. Section 4.2 of TR 37.817 states:

Model Inference is a function that provides AI/ML model inference output (e.g. predictions or decisions). Model Inference function may provide Model Performance Feedback to Model Training function when applicable. The Model Inference function is also responsible for data preparation (e.g. data pre-processing and cleaning, formatting, and transformation) based on Inference Data delivered by a Data Collection function, if required.

Output: The inference output of the AI/ML model produced by a Model Inference function.

Model Performance Feedback: It may be used for monitoring the performance of the AI/ML model, when available. Details of the Model Performance Feedback process are out of RAN3 scope.

As can be seen from TR 37.817, the Model Performance Feedback is intended to provide an indication on the performance of the AI/ML model, but it has not been defined yet.

Regarding the procedures used by the NG-RAN nodes to request and report feedback information the following agreements have been made during RAN3 #117-bis-e and #118 meetings. See RAN3_117bis-e_agenda_20221018_EOM1; RAN3_118_agenda_20221118_EOM.

Introduce a new Class 1 procedure for initiating the reporting of AI/ML Related Information and a Class 2 procedure for Data Reporting of AI/ML Related Information.

Reporting options for the new procedure used for AI/ML Related Information to be evaluated on a case-by-case basis. Possible reporting options are one-time and periodic reporting.

The new procedure is non-UE associated procedure. If needed, the procedure can be used to capture UE-associated information.

Procedures used for AI/ML support in the NG-RAN shall be “data type agnostic”.

A possible implementation of the above agreements is depicted in R3-225510 as follows.

FIG. 9 illustrates a process according to FIG. 1 from R3-225510: Example of signalling diagram for execution of AI/ML processes in NG-RAN, case of model training at NG-RAN).

In the message sequence of FIG. 9, each step can be described as follows:
NG-RAN Node 1 is assumed to host a trained model.
NG-RAN Node 1 signals to NG-RAN Node 2 an Xn SETUP REQUEST message.
NG-RAN Node 2 signals to NG-RAN Node 1 an Xn SETUP RESPONSE message.

If needed, NG-RAN Node 1 configures measurements at the UE and receives measurement reports accordingly.

In order to configure the process of input data reporting, NG-RAN node 1 signals to NG-RAN Node 2 the Xn: AI/ML Assistance Data Request message.

NG-RAN Node 2 replies with the Xn: AI/ML Assistance Data Response message, where it accepts reporting of the requested information.

NG-RAN Node 2 signals the Xn: AI/ML Assistance Data Update message to report the information requested to NG-RAN Node 1.

NG-RAN Node 1 may perform AI/ML based inference on the basis of the inputs received and of other information.

In order to configure the process of output data reporting, NG-RAN node 2 signals to NG-RAN Node 1 the Xn: AI/ML Assistance Data Request message.

NG-RAN Node 1 replies with the Xn: AI/ML Assistance Data Response message, where it accepts reporting of the requested information.

NG-RAN Node 1 signals the Xn: AI/ML Assistance Data Update message to report the information requested to NG-RAN Node 2.

In order to configure the process of feedback data reporting, NG-RAN node 1 signals to NG-RAN Node 2 the Xn: AI/ML Assistance Data Request message.

NG-RAN Node 2 replies with the Xn: AI/ML Assistance Data Response message, where it accepts reporting of the requested information.

NG-RAN Node 2 signals the Xn: AI/ML Assistance Data Update message to report the information requested to NG-RAN Node 1.

### SUMMARY

Certain challenges exist. For example, there may be a scenario where a first network node needs to retrieve from a second network node UE related information of particular UEs (e.g., UEs satisfying a certain grouping criteria). In such scenario, the first network node may send to the second network node a request for UE related information of the particular UEs, where the request includes identifier(s) identifying the particular UEs. However, in case an existing message (e.g., a message standardized in 3GPP TS) is used as such request, the IEs or fields of the existing message that may be used as the identifier(s) are limited, and thus a number of UE groups for which the first network node can request UE related information is limited. Accordingly, there is a need for a flexible and granular way to define and identify a group of UEs for which UE related information is requested.

In another example, in a case where the first network node requests from the second network node a series of UE related information, the second network node needs to send to the first network node the requested UE related information using a series of sequential reporting messages. In order to allow the first network node to link the UE related information included in each of the sequential reporting messages to the request, each reporting message needs to include a common identifier identifying the requested series of UE related information. However, existing identifier(s) such as UE XnAP IDs cannot be used as the common identifier identifying the requested series of UE related information because those existing identifiers are generally limited in time (their values change over time). Thus, there is a need for more time-resistant way of relating UE related information included in sequential reporting messages to the requested series of UE related information.

Accordingly, in one aspect, there is provided a method performed by a first network node. The method comprises transmitting towards a second network node a request message for requesting first user equipment, UE, related information, wherein the request message includes a first group UE identifier, ID, identifying a first group of one or more UEs for which the first UE related information is requested. The method further comprises, after transmitting the request message, receiving a reporting message which includes first UE related information for one or more UEs included in the first group of UEs. The reporting message includes one or more performance measurement results and one or more series IDs each of which identifies a UE associated with each of the one or more measurement results, and the reporting message was transmitted by the second network node.

In another aspect, there is provided a method performed by a second network node. The method comprises receiving from a first network node a request message for requesting first user equipment, UE, related information, wherein the request message includes a first group UE identifier, ID, identifying a first group of one or more UEs for which the first UE related information is requested; and after receiving the request message, transmitting the first network node a reporting message which includes first UE related information for one or more UEs included in the first group of UEs, wherein the reporting message includes one or more performance measurement results and one or more series IDs each of which identifies a UE associated with each of the one or more measurement results.

In another aspect, there is provided a computer program comprising instructions which when executed by processing circuitry cause the processing circuitry to perform the method of any one of the embodiments described above.

In another aspect, there is provided a carrier containing the computer program of any one of the embodiments described above, wherein the carrier is one of an electronic signal, an optical signal, a radio signal, and a computer readable storage medium.

In another aspect, there is provided a first network node. The first network node is configured to transmit towards a second network node a request message for requesting first user equipment, UE, related information, wherein the request message includes a first group UE identifier, ID, identifying a first group of one or more UEs for which the first UE related information is requested; and after transmitting the request message, receive a reporting message which includes first UE related information for one or more UEs included in the first group of UEs. The reporting message includes one or more performance measurement results and one or more series IDs each of which identifies a UE associated with each of the one or more measurement results, and the reporting message was transmitted by the second network node.

In another aspect, there is provided a second network node. The second network node is configured to receive from a first network node a request message for requesting first user equipment, UE, related information, wherein the request message includes a first group UE identifier, ID, identifying a first group of one or more UEs for which the first UE related information is requested; and after receiving the request message, transmit to the first network node a reporting message which includes first UE related information for one or more UEs included in the first group of UEs, wherein the reporting message includes one or more performance measurement results and one or more series IDs each of which identifies a UE associated with each of the one or more measurement results.

In another aspect, there is provided an apparatus. The apparatus comprises a processing circuitry and a memory, said memory containing instructions executable by said processing circuitry, whereby the apparatus is operative to perform the method of any one of the embodiments described above.

Some embodiments of this disclosure provide a flexible and granular way of identifying a group of UEs for which UE related information is requested and/or more time-resistant way of relating UE related information included in sequential reporting messages to the requested series of UE related information.

### BRIEF DESCRIPTION OF THE DRAWINGS

The accompanying drawings, which are incorporated herein and form part of the specification, illustrate various embodiments.

FIG. 1 shows a portion of a wireless network system according to some embodiments.

FIG. 2 shows a functional/block diagram for a message exchange according to some embodiments.

FIG. 3 shows a functional/block diagram for a machine learning framework according to some embodiments.

FIG. 4A shows a process according to some embodiments.

FIG. 4B shows a process according to some embodiments.

FIG. 5 shows an apparatus according to some embodiments.

FIG. 6 illustrates a message sequence known in the art.

FIG. 7 illustrates a message sequence known in the art.

FIG. 8 illustrates a message sequence known in the art.

FIG. 9 illustrates a message sequence known in the art.

### DETAILED DESCRIPTION

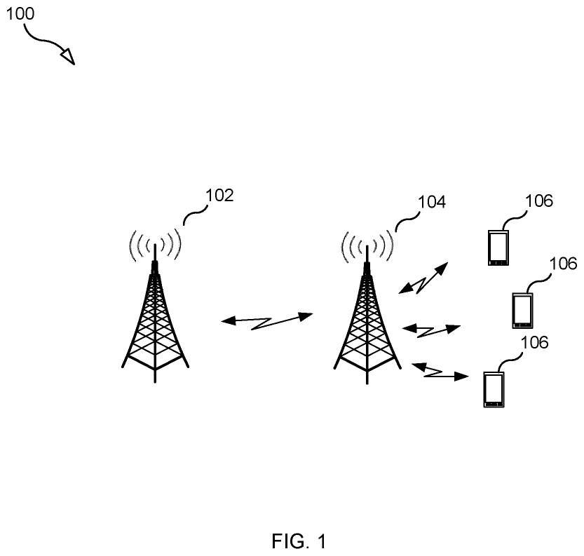

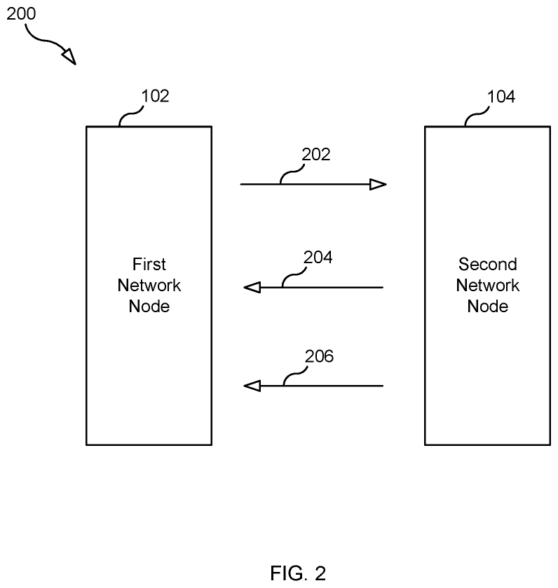

FIG. 1 shows a portion of a wireless network system 100 according to some embodiments. Wireless network system 100 comprises a first network node 102, a second network node 104, and one or more user equipments (UEs) 106. As shown in FIG. 2, the first network node 102 may be configured to transmit towards the second network node 104 a request message 202 for requesting UE related information. The second network node 104 may then gather the requested UE related information and transmit a reporting message 206 towards the first network node 102. Based on the received UE related information, the first network node 102 may train a machine learning (ML) model. Alternatively, the first network node 102 may forward the received UE related information to a different network node which is configured to train an ML model based on the UE related information.

In some embodiments, the ML model may be used for optimizing the performance of wireless network(s) provided by the first network node 102 and/or the second network node 104. In one example, the ML model may be configured to determine whether and/or when to perform a handover of a UE from a cell (e.g., a cell associated with the first network node 102, also referred to as serving cell) to another cell (e.g., a cell associated with the second network node, also referred to as target cell). In this example, in order to train the ML model, data related to previously performed handovers may be useful. Thus, in this example, the UE related information corresponds to data related to previously performed handovers (e.g., the timing of performing a handover, measurement data measured by a UE, which indicates performance of a wireless network before and after a handover, a cell ID identifying a cell from which a handover is performed for a UE, a cell ID identifying a cell to which a handover is performed, etc.).

In order to collect the right UE related information (i.e., the UE related information that is useful in training the ML model) from the second network node 104, it may be desirable for the first network node 102 to provide to the second network node 104 identification of one or more UE(s) of which the UE related information is needed. Thus, according to some embodiments, the request message 202 may include a group UE identifier identifying a first group of one or more UEs 106 for which the first network node 102 is requesting UE related information.

### 1. Request Message 202

### 1.1. Group UE Identifier Identifying a Group of UE(s)

In some embodiments, the first network node 102 may identify the group of UE(s) using an existing piece of information, such as the Mobility Information IE defined for the X2 and Xn application protocols. However in other embodiments, the group of UE(s) may be identified by a new IE (e.g., which may be encoded as a numerical value or an OCTET string).

Table 1 illustrates an example of UE group identifier achieved by reusing the Mobility Information IE. Table 1 is from Section 9.1.1.1 of 3GPP TS 38.423, e.g. 7.3.0, NG-RAN. In Table 1, the bold and italicized texts are additions to publicly available 3GPP specifications and are related to the embodiments described herein.

TABLE 1

| | IE type and | Semantics | | Assigned |
|---|---|---|---|---|
| IE/Group Name | reference | description | Criticality | Criticality |
| . . . | | | | |
| Mobility Information | BIT STRING | Information related | YES | ignore |
| | (SIZE (32)) | to the handover; | | |
| | | the source NG- | | |
| | | RAN node provides | | |
| | | it in order to enable | | |
| | | later analysis of the | | |
| | | conditions that led | | |
| | | to a wrong HO. | | |
| | | The IE may also | | |
| | | be used as an | | |
| | | identifier for the | | |
| | | purpose of | | |
| | | feedback | | |
| | | information | | |
| | | reporting | | |
| UE History Information from | 9.2.3.110 | | YES | ignore |
| the UE | | | | |
| IAB Node Indication | ENUMERATED | | YES | reject |
| | (true, . . . ) | | | |
| No PDU Session Indication | ENUMERATED | This IE applies only | YES | ignore |
| | (true, . . . ) | if the UE is an IAB- | | |
| | | MT. | | |
| Time Synchronisation | 9.2.3.153 | | YES | ignore |
| Assistance Information | | | | |
| QMC Configuration | 9.2.3.156 | | YES | ignore |
| Information | | | | |
| 5G ProSe Authorized | 9.2.3.159 | | YES | ignore |
| 5G ProSe PC5 QoS | 9.2.3.160 | This IE applies only | YES | ignore |
| Parameters | | if the UE is | | |
| | | authorized for 5G | | |
| | | ProSe services. | | |

Table 2 illustrates an example of UE group identifier achieved by using a new IE. Table 2 is from Section 9.1.1.1 of 3GPP TS 38.423 NG-RAN. In Table 2, the bold and italicized texts are additions to publicly available 3GPP specifications and are related to the embodiments described herein.

TABLE 2

| | IE type and | Semantics | | Assigned |
|---|---|---|---|---|
| IE/Group Name | reference | description | Criticality | Criticality |
| . . . | | | | |
| UE Group Identifier List | | List of UE groups | YES | Ignore |
| | | for which | | |
| | | feedback is | | |
| | | requested | | |
| >UE Group Identifier | BIT STRING | It identifies a | — | — |
| | (SIZE (32)) | group of UE for | | |
| | | which specific | | |
| | | information | | |
| | | reporting may be | | |
| | | triggered | | |
| UE History Information from | 9.2.3.110 | | YES | ignore |
| the UE | | | | |
| IAB Node Indication | ENUMERATED | | YES | reject |
| | (true, . . . ) | | | |
| No PDU Session Indication | ENUMERATED | This IE applies only | YES | ignore |
| | (true, . . . ) | if the UE is an IAB- | | |
| | | MT. | | |
| Time Synchronisation | 9.2.3.153 | | YES | ignore |
| Assistance Information | | | | |
| QMC Configuration | 9.2.3.156 | | YES | ignore |
| Information | | | | |
| 5G ProSe Authorized | 9.2.3.159 | | YES | ignore |
| 5G ProSe PC5 QoS | 9.2.3.160 | This IE applies only | YES | ignore |
| Parameters | | if the UE is | | |
| | | authorized for 5G | | |
| | | ProSe services. | | |

In grouping one or more UEs, the first network node 102 may group UE(s) based on a grouping criteria. In some embodiments, the grouping criteria may represent a common characteristic or parameter identifying the group of UEs, and can be represented by an identifier of the group itself, such as a “group-ID” or an “Event ID.” In some embodiments, the grouping criteria itself may serve as a group ID. In such embodiments, the request message 202 may indicate to the second network node 104 that if a UE satisfies the grouping criteria, the requested UE related information should be reported for the UE.

The grouping criteria may be based on particular mobility event(s) associated with certain cause(s). For example, the grouping criteria may represent a handover triggered by certain cause(s) (e.g., “handover due to load balancing assisted by AI/ML” or “AI/ML assisted load balancing”, or “AI/ML assisted mobility”). In this example, upon receiving the request 202, the second network node 104 may report to the first network node 102 UE related information for those UE(s) for which a handover triggered by certain cause(s) was performed.

Additionally or alternatively, the grouping criteria may be based on particular mobility event(s) associated with certain time period(s), certain start timing(s), certain end timing(s), and/or certain duration(s). For example, the grouping criteria may represent a handover triggered during a certain time period (e.g., between 9 am and 2 pm).

Additionally or alternatively, the grouping criteria may be based on the target frequency carrier for particular mobility event(s), the frequency carrier serving the UEs before and/or after particular mobility event(s), and/or one or more cells related to particular mobility event(s). For example, the grouping criteria may be based on the target frequency carriers for a handover, the frequency carriers serving UEs before and/or after performing a handover, cells to which UEs are being handed over, or cells from which UEs are being handed over.

Additionally or alternatively, the grouping criteria may be based on particular mobility event(s) associated with a Quality of Experience (QoE) reference or a measConfigAppLayerID—identifying the application layer measurements, as indicated in TS 38.331 v17.2.0—associated to a management based QoE configuration according to which the UEs of the group of UEs have been configured to collect QoE or RAN visible (RVQoE) measurements.

Additionally or alternatively, the grouping criteria may be based on particular mobility event(s) occurred in certain geographical location(s). For example, the group identifier may identify a set of cells, a set of tracking areas (TAs), and/or a set of public land mobile networks (PLMNs) UEs should be within, (i) before the mobility event(s), (ii) after the mobility event(s), or (iii) before and after the mobility event(s).

Additionally or alternatively, the grouping criteria may be based on the condition of a UE being in multi connectivity or that UEs are configured for conditional handover (CHO).

Additionally or alternatively, the grouping criteria may be based whether UEs are in cell edge or in good radio conditions.

Additionally or alternatively, the grouping criteria may be based whether UEs experienced too early handover (HO), too late HO, and/or Successful Handover Report (SHR).

In some embodiments, the grouping criteria may be dynamic, and may comprise two parts. The first part of the grouping criteria may be sent by the first network node 102 to the second network node. Then the second network node 104 can add the second part for a better granularity in the group of UEs. For example, the first network node 102 may first identify groups of UEs based on AI/ML triggered mobility (e.g., UEs that were handovered, where the handover of the UEs was triggered by the inference process of an ML model). Then, the second network node 104 may add more identification to the group ID such that only a portion of the UEs (e.g., UEs with similar first cell in the UE trajectory prediction, or UEs that are in Conditional Handover (CHO) are selected to correspond to the group ID. The ID can be preconfigured by a third node and the first and second network node fills in the corresponding parts.

As discussed above, there are various factors that may contribute to the grouping criteria, and in the embodiments of this disclosure, any one or a combination of those factors may be used for the grouping criteria.

In some embodiments, the request message 202 may include more than one group ID. In such embodiments, different types of UE related information may be requested for the different groups identified by different group IDs. For example, the request message 202 may include a first group ID identifying a first group of UEs and a second group ID identifying a second group of UEs. The request message 202 may also indicate that information regarding network latency should be reported for the first group of UEs and information regarding network throughput should be reported for the second group of UEs.

The parameters and identifiers associated to the events and UEs that should be grouped together by the second node 104 should be included in the mobility procedures triggered by the first network node 102, e.g. in the HO Request message to the second network node 104. A third node/system, such as the OAM, may have preconfigured a specific structure of the identification information and it might have configured such structure at the first node, for utilization in the feedback request and mobility procedures.

Referring back to FIG. 2, FIG. 2 shows an exemplary illustration of a message exchange between the first network node 102 and the second network node 104 for obtaining UE related information, according to some embodiments. The message exchange 200 may include the first network node 102 transmitting towards the second network node 104 request message 202. After receiving the request message 202, the second network node 104 may transmit towards the first network node 102 an acknowledgment message 204 and a reporting message 206.

As discussed above, the request message 202 is a request for requesting UE related information from the second network node 104. The UE related information for a given UE may comprise a series (periodic or not) of metrics samples, determined (e.g., measured) by the second network node 104 and may be reported to the first network node 102 in a time sequence/series (periodic or not) of reporting messages 206. For example, if the request message 202 is a request for a UE's measurement of network performance before a handover that has occurred between 2 pm and 4 pm, the second network node 104 may transmit to the first network node 102 a first reporting message 206 reporting a UE's measurement of network performance between 2 pm and 3 pm and a second reporting message 206 reporting a UE's measurement of network performance between 3 pm and 4 pm.

The request message 202 may also indicate time boundaries (a start time, and/or an end time within which the series of UE related feedback can be provided), a maximum/minimum number of per-UE feedback per messages—i.e. to indicate how many feedback instances can be signaled in one message, maximum/minimum/recommended number of feedback per individual UE in the group of UEs, and maximum/minimum/recommended number of feedbacks for the group of UEs.

The request message 202 may additionally indicate whether the second network node 104 is requested/recommended to send UE related information in a series of messages, first for certain UEs (e.g., UEs having certain characteristics) in the group of UEs, and then feedback related to other UEs belonging to the same group of UEs. Here, the characteristics can be any one or more of: using certain network slice(s), or certain UE capabilities, or using certain service(s).

In some embodiments, the first network node 102 can indicate as part of the request for UE related information to the second network node 104 indications/parameters. The indications/parameters indicate that the second network node 104 may be expected to/can report to the first network node 102 UE related information for a large number of UEs in a group of UEs over several messages.

The first network node 102 may indicate in the request message 202 a priority related to the UE related information. The priority may be based on the UE using of certain network slices (e.g., feedback for a UE using a slice for ultra-reliable and low-latency communication (URLCC) has higher priority—and has to be sent before—feedback for a UE using a slice for enhanced Mobile Broadband (eMBB)).

Additionally or alternatively, the priority may be based on the UE using of certain service or QoS attributes (e.g., feedback for a first UE using a first value of 5G QoS Identifier (5QI) has a higher priority—and has to be sent before—a feedback for a second UE using a second value of 5QI, or—in another example—a feedback for a first UE using a Guaranteed Bit Rate (GBR) QoS flow is to be sent before the feedback for a second UE using a non-GBR QoS flow).

Additionally or alternatively, the priority may be based on certain UE radio capabilities (e.g., feedback for a UE supporting a certain (higher) maximum number of carriers for carrier aggregation, etc., has to be sent before feedback for a UE supporting another (lower) number of carriers for carrier aggregation).

Additionally or alternatively, the priority may be based on the UE supporting certain Radio Access Technologies (RATs) (e.g., feedback for a UE supporting a first RAT and a second RAT should be sent before feedback for a UE only supporting the first RAT and not the second RAT).

Additionally or alternatively, the priority may be based on the information comprised in the UE related information. For instance, UE related information related to throughput is to be reported before UE related information related to UE/Network energy efficiency or UE battery consumption.

The request message 202 may indicate the timing/latency related UE related information, indicating that UE related information for UEs characterized by one or more of the aspects described for the priority indication, should be provided within a certain time or within a certain delay, or within a certain number of report messages.

The request message 202 may also indicate a number (maximum/minimum/recommended) of UE related information per individual UE corresponding to a given priority that can be included in a single reporting message. With this indication in one possible example, if the group of UEs comprises UE1 and UE2, wherein UE1 is at higher priority compared to UEs (in terms of UE related information reporting), the first network node 102 can request the second network node 104 to include in a single message up to “N” UE related information (if available) for UE1. The second network node 104 can then send in the same reporting message additional “M” UE related information for UE2 (if available).

In such embodiments described above, the request message 202 may include an indication, indicating that all UE related information corresponding to a first priority are to be reported strictly before any UE related information corresponding to a second priority.

The first network node 102 can indicate to the second network node 104 to retrieve application layer data from the UEs belonging to a certain group of UEs (e.g., RAN Visible QoE (RVQoE) metrics) collected according to a certain recording periodicity (e.g., as derived from a reporting periodicity configured for RVQoE measurements).

The request message 202 may correspond to an existing message (e.g., a handover request) that is defined in the 3GPP TS 38.423 or a new message (“AI/ML Assistance Data Request message”). Also, in case the request message 202 corresponds to an existing message, the UE group ID may correspond to an existing IE or a new IE in the existing message.

If the existing IE is used as the UE group ID, there is no need to include a new IE in the message. But using the existing IE as the UE group ID may lead to some confusion and make an implementation more cumbersome (e.g., because there should be provided a way to distinguish the scenario of only one UE involved as compared to the scenario where multiple UEs are involved).

Using a new IE as the UE group ID will make the signaling cleaner and easier to handle. Another advantage is that a new IE can provide (from the start, of by means of future extensions) the possibility to transfer information (e.g., series characteristics, and/or UE performance) which cannot fit in the limited encoding space of the existing IE if the existing IE is not extendable, e.g., when the existing IE is the Mobility Information IE defined in the TS 38.423. Further advantage of using a new IE to signal the UE group ID is that the new IE allows transmitting multiple UE group IDs. This is not possible with the existing IEs/fields (e.g., the Mobility Information IE, the Cause Value IE) because each of these existing IEs/fields are already encoded as a single value, and thus changing any of these existing IEs/fields would create backward compatibility issues.

### 2. Reporting Message

Referring back to FIG. 2, after receiving the request message 202 and assessing the requirements for the UE related information, the second network node 104 may send to the first network node 102 an (optional) acknowledgment message 204 acknowledging the receipt of the request message 202. In some embodiments, the acknowledgement message 204 may indicate whether the request message 202 is accepted or not (i.e., whether the request for UE related information is accepted or not). In some embodiments, the acknowledgement message 204 may indicate whether the request message 202 is partially accepted or wholly accepted.

In case the second network node 104 accepts the request message 202, the second network node 104 may generate a unique identifier (e.g., REPORT_ID) and include it in the acknowledgment message 204 and in every subsequent reporting message 206 for the request so that the first network node 102 can correlate the acknowledgement message 204 and/or the reporting message(s) 206 with the request message 202.

Upon receiving from the first network node 102 a request message 202 for UE related information, which includes a particular UE group ID, the second network node 104 may need to retrieve/collect/obtain UE related information for UEs associated with the particular UE group ID.

In order for the second network node 104 to retrieve the correct UE related information for UEs corresponding to the particular UE group ID, the second network node 104 must have mapping information mapping this particular UE group ID to UE(s).

One way for the second network node 104 to obtain such mapping information is via a handover request. For example, during a handover process of a UE from a cell (i.e. serving cell) in the first network to another cell (i.e. target cell) in the second network, the first network node 102 transmits to the second network node 104 a handover request for this UE, which includes the particular UE group ID, thereby allowing the second network to obtain this mapping information.

There may be a scenario where a UE is associated with more than one group ID. In such case, the handover request may include multiple UE group IDs.

### 2.1 Series ID

After receiving the request message 202, the second network node 104 may begin to collect, prepare, and report UE related information to the first network node 102. In some embodiments, the second network node 104 may include in each reporting message 206 a unique identifier series ID. The series ID allows the first network node to identify the UE related information belonging to a given series across the entire sequence of reporting messages. The second network node 104 may include the series ID in embodiments where reporting is performed in a time sequence of reporting messages.

For example, in case the request message 202 is for requesting a series of measurement data, upon receiving the request message 202, the second network node 104 may send to the first network node 102 a first reporting message 206 containing first measurement data and a second reporting message 206 containing second measurement data that is obtained after obtaining the first measurement data. In this example, it may be desirable for the first network node 102 to relate the first and second measurement data to the requested series of measurement data. Thus, in some embodiments, each of the first and second reporting message 206 may include a series ID which may be used by the first network node 102 to link the first and second measurement data to the requested series of measurement data.

The series ID may be provided to identify all measurements associated to the same UE. In general, the series ID helps the first network node 102 (requesting node) to group together all feedback data associated to the same “process”, e.g. to the same UE subject to a mobility event.

The second network node will also include the identification information previously received from the first network node in the request message 202 (e.g. UE group ID) which will identify the group of UEs to which the feedback information belongs.

A possible implementation of the reporting message 206 sent from second network node to first network node is given in Table 3. In Table 3, the bold and italicized texts are additions to publicly available 3GPP specifications and are related to the embodiments described herein.

TABLE 3

| | IE type and | Semantics | | Assigned |
|---|---|---|---|---|
| IE/Group Name | reference | description | Criticality | Criticality |
| Message Type | 9.2.3.1 | | YES | ignore |
| NG-RAN node1 | INTEGER | Allocated by | YES | reject |
| Measurement ID | (1 . . . 4095, . . . ) | NG-RAN node₁ | | |
| NG-RAN node2 | INTEGER | Allocated by | YES | reject |
| Measurement ID | (1 . . . 4095, . . . ) | NG-RAN node₂ | | |
| UE Group Measurement | | | YES | ignore |
| Result | | | | |
| >UE Group | | | YES | ignore |
| Measurement Result | | | | |
| Item | | | | |
| >>UE Group ID | | It identifies a | — | |
| | | group of UE for | | |
| | | which specific | | |
| | | information | | |
| | | reporting is be | | |
| | | triggered | | |
| >>UE Performance | | | | |
| Indicator List | | | | |
| >>>UE Performance | 9.2.3.yy | | | |
| Measurements | | | | |
| >>>Measurement | INTEGER | It identifies a | | |
| Series ID | (1 . . . 4095, . . .) | series of | | |
| | | information | | |
| >>>Series | ENUMERATED | | | |
| Characteristics | (Average, Peak | | | |
| | to Mean, | | | |
| | 95%, cell edge | | | |
| >>>UE Assistant | NG-RAN node | | YES | ignore |
| Identifier | UE XnAP ID | | | |
| | 9.2.3.16 | | | |

### 3. Energy Saving Event

In another embodiment, the first network node 102 may trigger a request for UE related information that may be associated with an energy saving event. The energy saving event may include switching off a cell, changing coverage of a cell, and changing the configuration of a cell.

The UE related information request message may contain information about the energy saving event. The information about the energy saving event may include one or more of the following:

| | |
|---|---|
| i. | A list of one or more cells to be deactivated (e.g. identified by their |
| | Cell Global Identity (CGIs)); |
| ii. | A list of one or more cells whose coverage may be modified (e.g. |
| | identified by their CGIs); and/or |
| iii. | A list of one or more cells whose configuration may be modified |
| | (e.g. identified by their CGIs). |

The UE related information request may contain the information included in the request message described in the paragraphs describing FIG. 2. In particular, the request message 202 may include information about the request to receive UE related information about the performance of UEs affected by the energy saving action.

As in previous embodiments, the request message may include UE group identifier or equivalent parameters. One example of the request message is illustrated in Table 4 below.

In the example of Table 4, the message is sent by a first NG-RAN node to a second NG-RAN node to initiate the requested assistance data reporting in support to AI/ML functions, according to the parameters given in the message. In Table 4, the bold and italicized texts are additions to publicly available 3GPP specifications and are related to the embodiments described herein.

TABLE 4

| | IE type and | Semantics | | Assigned |
|---|---|---|---|---|
| IE/Group Name | reference | description | Criticality | Criticality |
| Message Type | 9.2.3.1 | | YES | reject |
| NG-RAN node1 | INTEGER | Allocated by NG- | YES | reject |
| Measurement ID | (1 . . . 4095, . . . ) | RAN node₁ | | |
| NG-RAN node2 | INTEGER | Allocated by NG- | YES | ignore |
| Measurement ID | (1 . . . 4095, . . . ) | RAN node₂ | | |
| Registration Request | ENUMERATED(start, | Type of request for | YES | reject |
| | stop, add, . . . ) | which the | | |
| | | assistance data is | | |
| | | required. | | |
| Report Characteristics | BITSTRING | Each position in the | YES | reject |
| | (SIZE(128)) | bitmap indicates | | |
| | | measurement object | | |
| | | the NG-RAN node 2 | | |
| | | is requested to | | |
| | | report. | | |
| | | First Bit = Predicted | | |
| | | Radio Resources | | |
| | | Periodic, | | |
| | | Second Bit = | | |
| | | Current Energy | | |
| | | Efficiency Periodic, | | |
| | | Third Bit = Predicted | | |
| | | Energy Efficiency | | |
| | | Periodic | | |
| | | Fourth Bit = UE | | |
| | | Performance | | |
| | | Indicator. | | |
| | | Other bits shall be | | |
| | | ignored by the NG- | | |
| | | RAN node 2. | | |
| Cell To Report List | | Cell ID list to which | YES | ignore |
| | | the request applies. | | |
| >Cell To Report Item | | | — | |
| >>Cell ID | Global NG-RAN | | — | |
| | Cell Identity | | | |
| | 9.2.2.27 | | | |
| Reporting Periodicity | ENUMERATED | Periodicity that can | YES | ignore |
| | (500 ms, 1000 ms, | be used for | | |
| | 2000 ms, 5000 ms, | reporting. | | |
| | 10000 ms, . . . ) | | | |
| Cells Affected by Energy | | Cell ID list for | YES | ignore |
| Efficiency Action List | | which energy | | |
| | | efficiency actions | | |
| | | are applied. | | |
| >Cell To Report Item | | | — | |
| >>Cell ID | Global NG-RAN | | — | |
| | Cell Identity | | | |
| | 9.2.2.27 | | | |
| UE Group ID | | It identifies a | — | |
| | | group of UE for | | |
| | | which specific | | |
| | | information | | |
| | | reporting is be | | |
| | | triggered | | |

In the table above, the first node signals to the second node a list of cells affected by an energy efficiency action. The first node also signals a UE Group ID. In the request message the first node may signal that UE related information is requested from the second node. Such formulation may allow the second node to understand that UE related information needs to be signaled for those UEs that are affected by the energy efficiency actions applied to the cells listed in the message.

UEs that are affected by such energy efficiency actions may be:

UEs under the coverage of the cells affected by the energy efficiency actions;
UEs served by cells affected by the energy efficiency actions;
UEs served by cells neighboring cells affected by the energy efficiency actions; and/or
UEs whose performance is impacted by the energy efficiency actions applied to the listed cells, e.g. UEs
served by a cell where the cells affected by the energy efficiency actions have offloaded traffic.

The second network node is therefore able to signal UE related information for such UEs to the first network node in a similar way to the above embodiments.

The message used for UE related information reporting may contain the UE Group ID (or UE group IDs), to enable the first node to understand that UE related information concerns UEs related or impacted by the energy saving actions taken. The reporting message may also include a Series ID to enable the first node to identify the group of UE related information measurements that constitute a measurement time series.

### 4. Training a Machine Learning Model

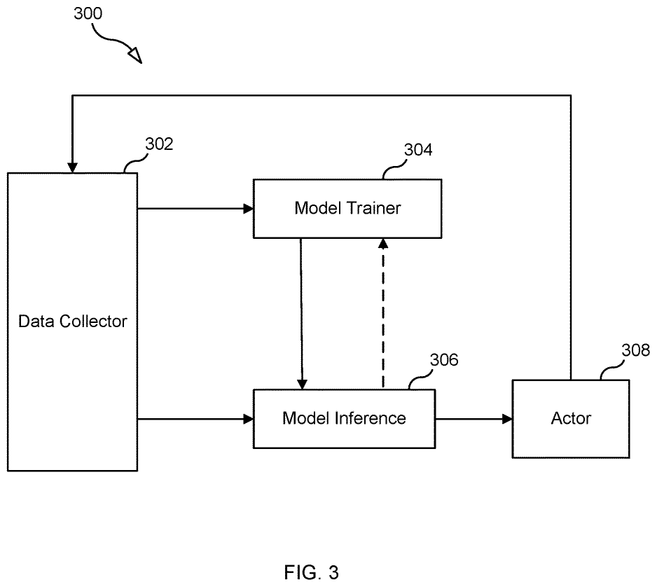

The UE related information obtained in the reporting message 206 may be used to train a machine learning model. FIG. 3 illustrates an artificial intelligence/machine learning framework according to some embodiments. The framework 300 comprises a data collector 302, a model trainer 304, a model inference 306, and an actor 308. The data collector 302 may receive UE related information from the actor 308. In some embodiments, the first network node 102 may act as the data collector 302 obtaining UE related information from the second network node 104. The data collector may then provide the collected UE related information to the model trainer 304 and the model inference 306.

The model trainer 304 receives training data, the collected UE related information, from the data collector 302 and model performance feedback for the model interface 306. The model trainer 304 may train, validate, and test a machine learning model using the training data and model performance feedback. The machine learning model may be embodied as any type of artificial intelligence or machine learning model. In some embodiments, the first network node 102 may act as the model trainer 304 training the machine learning model using the UE related information. The model trainer 304 may then transmit the machine learning model to the model interface 306.

The model interface 306 receives the inference data, the collected UE related information, from the data collector 302 and the trained machine learning model from the model trainer 304. In embodiments where the model interface 306 already has a machine learning model, the model interface 306 may receive an updated model from the model trainer 304. The model inference may then obtain one or more actions for the actor 308 through inputting the inference data into the machine learning model. The actions may include one or more network related actions (e.g., energy saving event). The model inference 306 may then transmit the actions to the actor 308 to perform the actions. In some embodiment, the model inference 306 may also transmit model performance feedback to the model trainer 304.

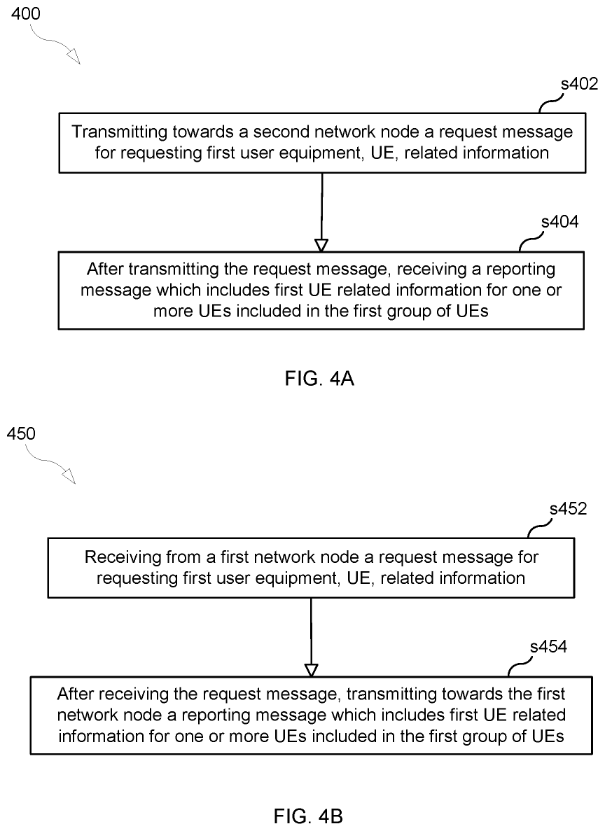

FIG. 4A shows a process 400 performed by the first network node 102 according to some embodiments. Process 400 may begin with step s402. Step s402 comprises transmitting towards a second network node a request message for requesting first user equipment, UE, related information, wherein the request message includes a first group UE identifier, ID, identifying a first group of one or more UEs for which the first UE related information is requested. Step s404 comprises, after transmitting the request message, receiving a reporting message which includes first UE related information for one or more UEs included in the first group of UEs, wherein the reporting message includes one or more performance measurement results and one or more series IDs each of which identifies a UE associated with each of the one or more measurement results, and the reporting message was transmitted by the second network node.

In some embodiments, process 400 further comprises grouping one or more UEs into the first group of UEs based on a first grouping criteria.

In some embodiments, the request message includes a second group UE identifier identifying a second group of one or more UEs for which second UE related information is requested, grouping one or more UEs into the second group of UEs based on a second grouping criteria, and the first grouping criteria and the second grouping criteria being different.

In some embodiments, the first grouping criteria is related to any one or more of a particular mobility event, a quality of experience, QoE, reference, a connectivity state of a UE, a configuration of a UE, and/or a capability of a UE.

In some embodiments, the first grouping criteria is based on any one or more of: the particular mobility event triggered by a particular cause; and/or the particular mobility event i) occurred during a given duration, ii) started at or after a given start time, and/or iii) ended at or after a given end time.

In some embodiments, the particular cause is a machine learning, ML, model triggering the particular mobility event.

In some embodiments, the particular mobility event is a handover of a UE from a first group of one or more cells to a second group of one or more cells, and the first grouping criteria is based on any one or more of: i) a target frequency carrier of the handover; ii) a frequency carrier serving a UE before the handover; iii) the first group of one or more cells; iv) the second group of one or more cells; v) an indication that the handover occurred before a desired handover timing; vi) an indication that the handover occurred after a desired handover timing; vii) one or more tracking areas, TAs, before the handover; viii) one or more TAs after the handover; ix) one or more public land mobile networks, PLMNs, before the handover; x) one or more PLMNs, after the handover; xi) one or more geographical areas before the handover; and/or xii) one or more geographical areas after the handover.

In some embodiments, the connectivity state of a UE indicates whether a UE is in a multi-connectivity state and/or whether a UE is in cell edge or poor radio coverage.

In some embodiments, the request message indicates any one or more of: a start timing of reporting first UE related information; an end timing of reporting first UE related information; a time duration of reporting first UE related information; a maximum number of feedback data instances in one reporting message; a minimum number of feedback data instances in one reporting message; a recommended number of feedback data instances in one reporting message and/or priority information related to the UE related information.

In some embodiments, each of the one or more series IDs identifies a UE which satisfies the first grouping criteria.

In some embodiments, the reporting message includes the first group UE identifier.

In some embodiments, the reporting message includes a series characteristic, the series characteristic identifying a type of performance measurement of at least one of the one or more performance measurement results.

In some embodiments, the method comprises, after transmitting the request message, transmitting towards the second network node a handover message triggering a handover of a UE from a cell of the first network node to another cell of the second network node, wherein the handover message comprises the first group ID.

In some embodiments, the reporting message comprises a first instance of performance result obtained at a first timing for a first UE and a series ID identifying the first UE; the method comprises receiving a second reporting message which comprises a second instance of performance result obtained at a second timing for the first UE and the series ID identifying the first UE; and the second timing is later than the first timing.

In some embodiments, the process 400 comprises training an ML model based on the first UE related information or forwarding the first UE related information to a third network node for training an ML model.

In some embodiments, the priority information indicates a priority level of a UE for which the first UE related information is requested and/or a priority level of an information type requested in the request message.

In some embodiments, the priority level of the UE is determined based on (i) whether the UE is associated with any one or more of a certain network slice, a certain service, or a certain QoS attribute, (ii) radio capability of the UE, and/or (iii) information about radio access technology that the UE supports.

In some embodiments, the first UE related information corresponds to a first information type and a second information type, and the priority information indicates that a priority level of the first information type is higher than a priority level of the second information type.

In some embodiments, the request message indicates how to report UE related information for the UE having the priority level and/or how to report UE related information corresponding to the information type having the priority level.

FIG. 4B shows a process 450 performed by second network node 104. Process 450 may begin with step s452. Step s452 comprises receiving from a first network node (102) a request message for requesting first user equipment, UE, related information, wherein the request message includes a first group UE identifier, ID, identifying a first group of one or more UEs for which the first UE related information is requested. Step s454 comprises, after receiving the request message, transmitting towards the first network node a reporting message which includes first UE related information for one or more UEs included in the first group of UEs, wherein the reporting message includes one or more performance measurement results and one or more series IDs each of which identifies a UE associated with each of the one or more measurement results.

In some embodiments, one or more UEs is grouped into the first group of UEs based on a first grouping criteria.

In some embodiments, the request message includes a second group UE identifier identifying a second group of one or more UEs for which second UE related information is requested, grouping one or more UEs into the second group of UEs based on a second grouping criteria, and the first grouping criteria and the second grouping criteria being different.

In some embodiments, the first grouping criteria is related to any one or more of a particular mobility event, a quality of experience, QoE, reference, a connectivity state of a UE, a configuration of a UE, and/or a capability of a UE.

In some embodiments, the first grouping criteria is based on any one or more of: the particular mobility event triggered by a particular cause; and/or the particular mobility event i) occurred during a given duration, ii) started at or after a given start time, and/or iii) ended at or after a given end time.

In some embodiments, the particular cause is a machine learning, ML, model triggering the particular mobility event.

In some embodiments, the particular mobility event is a handover of a UE from a first group of one or more cells to a second group of one or more cells, and the first grouping criteria is based on any one or more of: i) a target frequency carrier of the handover; ii) a frequency carrier serving a UE before the handover; iii) the first group of one or more cells; iv) the second group of one or more cells; v) an indication that the handover occurred before a desired handover timing; vi) an indication that the handover occurred after a desired handover timing; vii) one or more tracking areas, TAs, before the handover; viii) one or more TAs after the handover; ix) one or more public land mobile networks, PLMNs, before the handover; x) one or more PLMNs, after the handover; xi) one or more geographical areas before the handover; and/or xii) one or more geographical areas after the handover.

In some embodiments, the connectivity state of a UE indicates whether a UE is in a multi-connectivity state and/or whether a UE is in cell edge or poor radio coverage.

In some embodiments, the request message indicates any one or more of: a start timing of reporting first UE related information; an end timing of reporting first UE related information; a time duration of reporting first UE related information; a maximum number of feedback data instances in one reporting message; a minimum number of feedback data instances in one reporting message; a recommended number of feedback data instances in one reporting message and/or priority information related to the UE related information.

In some embodiments, each of the one or more series IDs identifies a UE which satisfies the first grouping criteria.

In some embodiments, the reporting message includes the first group UE identifier.

In some embodiments, the reporting message includes a series characteristic, the series characteristic identifying a type of performance measurement of at least one of the one or more performance measurement results.

In some embodiments, process 450 comprises after receiving the request message, receiving from the first network node a handover message triggering a handover of a UE from a cell of the first network node to another cell of the second network node, wherein the handover message comprises the first group ID.

In some embodiments, the reporting message comprises a first instance of performance result obtained at a first timing for a first UE and a series ID identifying the first UE; the process 450 comprises transmitting towards the first network node a second reporting message which comprises a second instance of performance result obtained at a second timing for the first UE and the series ID identifying the first UE; and the second timing is later than the first timing.

In some embodiments, an ML model is trained based on the first UE related information.

In some embodiments, the priority information indicates a priority level of a UE for which the first UE related information is requested and/or a priority level of an information type requested in the request message.

In some embodiments, the priority level of the UE is determined based on (i) whether the UE is associated with any one or more of a certain network slice, a certain service, or a certain QoS attribute, (ii) radio capability of the UE, and/or (iii) information about radio access technology that the UE supports.

In some embodiments, the first UE related information corresponds to a first information type and a second information type, and the priority information indicates that a priority level of the first information type is higher than a priority level of the second information type.

In some embodiments, the request message indicates how to report UE related information for the UE having the priority level and/or how to report UE related information corresponding to the information type having the priority level.

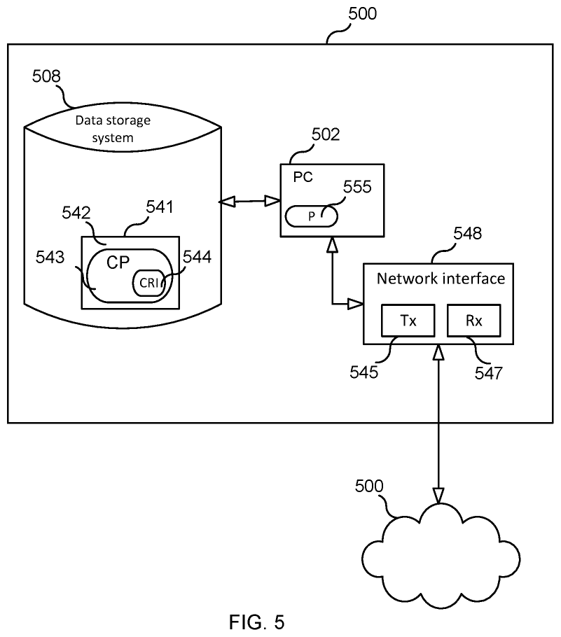

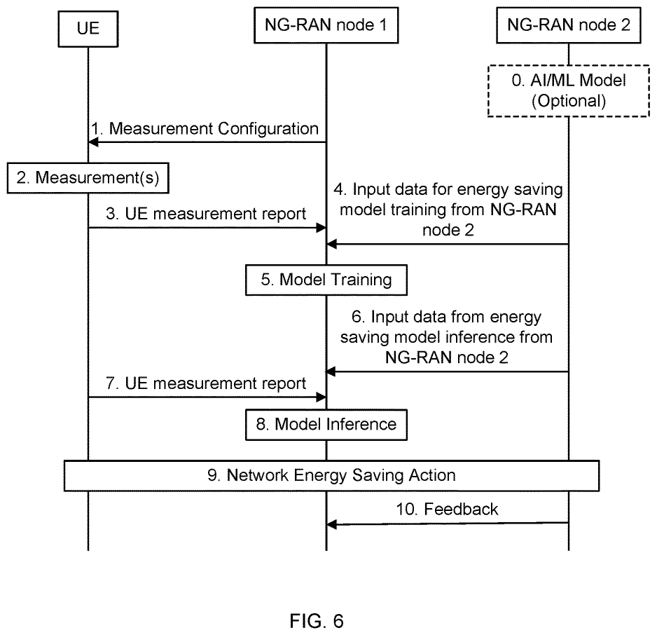

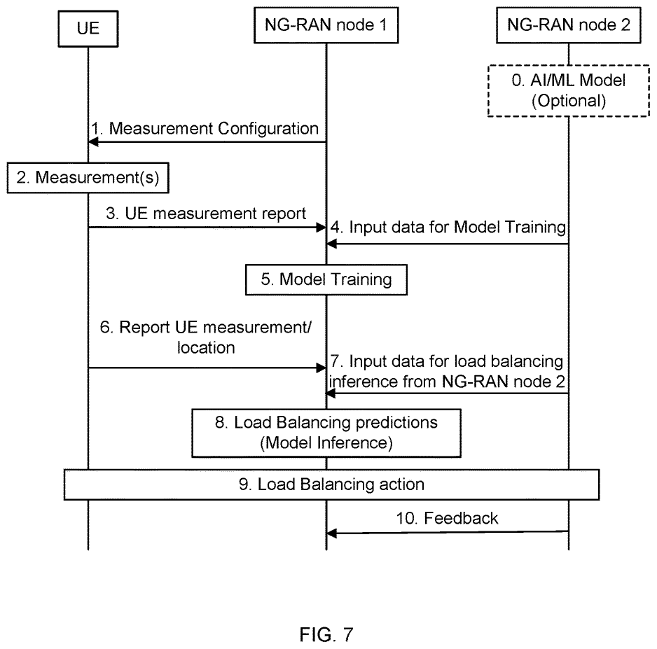

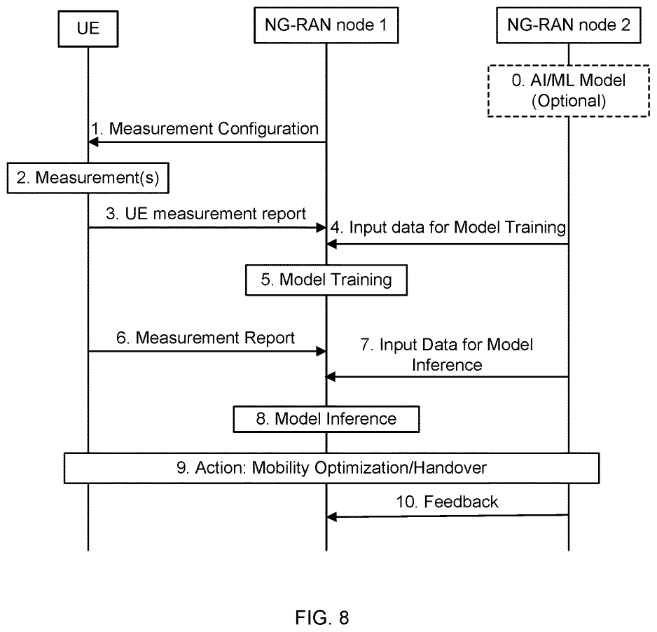

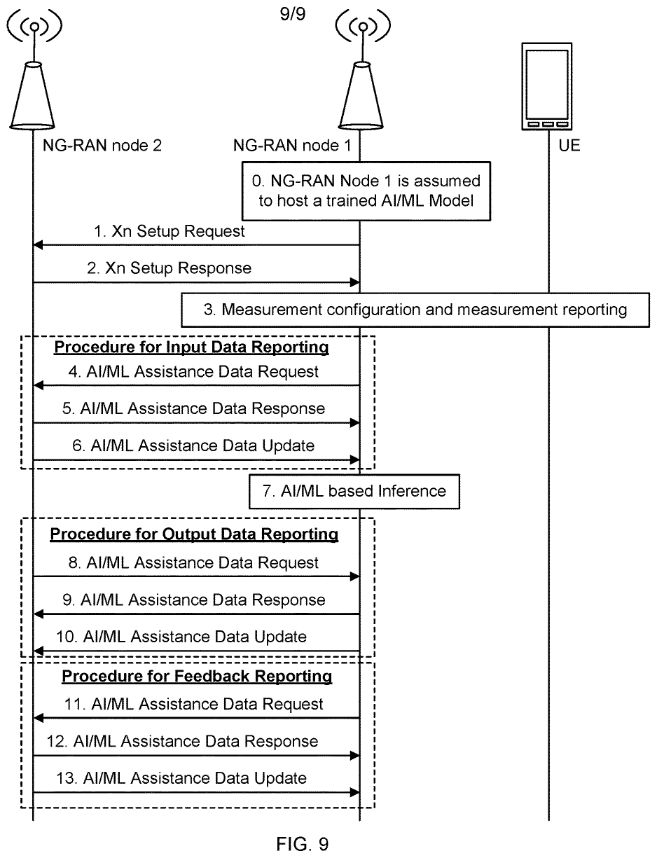

FIG. 5 is a block diagram of an apparatus (e.g., a first 102 and/or second 104 network node) according to some embodiments. Apparatus 500 may perform any of the methods or processes described above. As shown in FIG. 5, the apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., the network node may be a distributed computing apparatus); at least one network interface 548 comprising a transmitter (Tx) 545 and a receiver (Rx) 547 for enabling the network node to transmit data to and receive data from other nodes connected to a network 500 (e.g., an Internet Protocol (IP) network) to which network interface 548 is connected (directly or indirectly) (e.g., network interface 548 may be wirelessly connected to the network 500, in which case network interface 548 is connected to an antenna arrangement); and a storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes the network node to perform steps described herein (e.g., steps described herein with reference to one or more of the flow charts). In other embodiments, the first network node 102 may be configured to perform steps described herein without the need for code. That is, for example, PC 502 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

### Terminology

A network node can e.g. be a RAN node, an OAM, a Core Network node, an Service Management and Orchestration function (SMO), a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node, a function implemented in an Open RAN, O-RAN.

By UE group or UE grouping a group of UEs is intended that are grouped based on a set of one or more criteria according to which UEs are selected and for which feedback data is generated.

The term event in this application is generic and it may refer to one or multiple types of events. The application focusses on mobility events, but this should not restrict its applicability to other types of events where the method of identifying the UEs for which feedback is provided can be achieved by means of signaling of the proposed new information.

For further clarification of the present disclosure, below follows a list of non-limiting embodiments of the disclosure:

1. A method (400) performed by a first network node (102), the method comprising:
transmitting (s402) towards a second network node (104) a request message for requesting first user
equipment, UE, related information, wherein the request message includes a first group UE identifier, ID,
identifying a first group of one or more UEs for which the first UE related information is requested; and
after transmitting the request message, receiving (s404) a reporting message which includes first UE
related information for one or more UEs included in the first group of UEs, wherein
the reporting message includes one or more performance measurement results and one or more series
IDs each of which identifies a UE associated with each of the one or more measurement results, and the reporting
message was transmitted by the second network node.
2. The method of claim 1, comprising:
grouping one or more UEs into the first group of UEs based on a first grouping criteria.
3. The method of claim 2, wherein
the request message includes a second group UE identifier identifying a second group of one or more
UEs for which second UE related information is requested,
grouping one or more UEs into the second group of UEs based on a second grouping criteria, and
the first grouping criteria and the second grouping criteria being different.
4. The method of claim 2 or 3, wherein the first grouping criteria is related to any one or more of a
particular mobility event, a quality of experience, QoE, reference, a connectivity state of a UE, a configuration of a
UE, and/or a capability of a UE.
5. The method of claim 4, wherein the first grouping criteria is based on any one or more of:
the particular mobility event triggered by a particular cause; and/or
the particular mobility event i) occurred during a given duration, ii) started at or after a given start time,
and/or iii) ended at or after a given end time.
6. The method of claim 5, wherein the particular cause is a machine learning, ML, model triggering the
particular mobility event.
7. The method of any of claims 3-6, wherein
the particular mobility event is a handover of a UE from a first group of one or more cells to a second
group of one or more cells, and
the first grouping criteria is based on any one or more of:
i) a target frequency carrier of the handover;
ii) a frequency carrier serving a UE before the handover;
iii) the first group of one or more cells;
iv) the second group of one or more cells;
v) an indication that the handover occurred before a desired handover timing;
vi) an indication that the handover occurred after a desired handover timing;
vii) one or more tracking areas, TAs, before the handover;
viii) one or more TAs after the handover;
ix) one or more public land mobile networks, PLMNs, before the handover;
x) one or more PLMNs, after the handover;
xi) one or more geographical areas before the handover; and/or
xii) one or more geographical areas after the handover.
8. The method of any one of claims 4-7, wherein the connectivity state of a UE indicates whether a UE is
in a multi-connectivity state and/or whether a UE is in cell edge or poor radio coverage.
9. The method of any one of claims 1-8, wherein the request message indicates any one or more of:
a start timing of reporting first UE related information;
an end timing of reporting first UE related information;
a time duration of reporting first UE related information;
a maximum number of feedback data instances in one reporting message;
a minimum number of feedback data instances in one reporting message;
a recommended number of feedback data instances in one reporting message and/or
priority information related to the UE related information.
10. The method of any one of claims 2-9, wherein each of the one or more series IDs identifies a UE
which satisfies the first grouping criteria.
11. The method of any of claims 1-10, wherein the reporting message includes the first group UE
identifier.
12. The method of any of claims 1-11, wherein the reporting message includes a series characteristic,
the series characteristic identifying a type of performance measurement of at least one of the one or more
performance measurement results.
13. The method of any one of claims 1-12, the method comprising:
after transmitting the request message, transmitting towards the second network node a handover
message triggering a handover of a UE from a cell of the first network node to another cell of the second network
node, wherein
the handover message comprises the first group ID.
14. The method of any one of claims 1-12, wherein
the reporting message comprises a first instance of performance result obtained at a first timing for a first
UE and a series ID identifying the first UE;
the method comprises receiving a second reporting message which comprises a second instance of
performance result obtained at a second timing for the first UE and the series ID identifying the first UE; and
the second timing is later than the first timing.
15. The method of any one of claims 1-14, comprising:
training an ML model based on the first UE related information or forwarding the first UE related
information to a third network node for training an ML model.
16. The method of claim 9, wherein the priority information indicates a priority level of a UE for which the
first UE related information is requested and/or a priority level of an information type requested in the request
message.
17. The method of claim 16, wherein the priority level of the UE is determined based on (i) whether the
UE is associated with any one or more of a certain network slice, a certain service, or a certain QoS attribute, (ii)
radio capability of the UE, and/or (iii) information about radio access technology that the UE supports.
18. The method of claim 16, wherein
the first UE related information corresponds to a first information type and a second information type, and
the priority information indicates that a priority level of the first information type is higher than a priority
level of the second information type.
19. The method of any one of claims 16-18, wherein the request message indicates how to report UE
related information for the UE having the priority level and/or how to report UE related information corresponding
to the information type having the priority level.
20. A method (450) performed by a second network node (104), the method comprising:
receiving (s452) from a first network node (102) a request message for requesting first user equipment,
UE, related information, wherein the request message includes a first group UE identifier, ID, identifying a first
group of one or more UEs for which the first UE related information is requested; and
after receiving the request message, transmitting (s454) towards the first network node a reporting
message which includes first UE related information for one or more UEs included in the first group of UEs,
wherein
the reporting message includes one or more performance measurement results and one or more series
IDs each of which identifies a UE associated with each of the one or more measurement results.
21. The method of claim 20, wherein one or more UEs is grouped into the first group of UEs based on a
first grouping criteria.
22. The method of claim 21, wherein
the request message includes a second group UE identifier identifying a second group of one or more
UEs for which second UE related information is requested,
grouping one or more UEs into the second group of UEs based on a second grouping criteria, and
the first grouping criteria and the second grouping criteria being different.
23. The method of claim 21 or 22, wherein the first grouping criteria is related to any one or more of a
particular mobility event, a quality of experience, QoE, reference, a connectivity state of a UE, a configuration of a
UE, and/or a capability of a UE.
24. The method of claim 23, wherein the first grouping criteria is based on any one or more of:
the particular mobility event triggered by a particular cause; and/or
the particular mobility event i) occurred during a given duration, ii) started at or after a given start time,
and/or iii) ended at or after a given end time.
25. The method of claim 24, wherein the particular cause is a machine learning, ML, model triggering the
particular mobility event.
26. The method of any of claims 22-25, wherein
the particular mobility event is a handover of a UE from a first group of one or more cells to a second
group of one or more cells, and
the first grouping criteria is based on any one or more of:
i) a target frequency carrier of the handover;
ii) a frequency carrier serving a UE before the handover;
iii) the first group of one or more cells;
iv) the second group of one or more cells;
v) an indication that the handover occurred before a desired handover timing;
vi) an indication that the handover occurred after a desired handover timing;
vii) one or more tracking areas, TAs, before the handover;
viii) one or more TAs after the handover;
ix) one or more public land mobile networks, PLMNs, before the handover;
x) one or more PLMNs, after the handover;
xi) one or more geographical areas before the handover; and/or
xii) one or more geographical areas after the handover.
27. The method of any one of claims 23-26, wherein the connectivity state of a UE indicates whether a
UE is in a multi-connectivity state and/or whether a UE is in cell edge or poor radio coverage.
28. The method of any one of claims 20-27, wherein the request message indicates any one or more of:
a start timing of reporting first UE related information;
an end timing of reporting first UE related information;
a time duration of reporting first UE related information;
a maximum number of feedback data instances in one reporting message;
a minimum number of feedback data instances in one reporting message;
a recommended number of feedback data instances in one reporting message and/or
priority information related to the UE related information.
29. The method of any one of claims 21-28, wherein each of the one or more series IDs identifies a UE
which satisfies the first grouping criteria.
30. The method of any of claims 20-29, wherein the reporting message includes the first group UE
identifier.
31. The method of any of claims 20-30, wherein the reporting message includes a series characteristic,
the series characteristic identifying a type of performance measurement of at least one of the one or more
performance measurement results.
32. The method of any one of claims 20-31, the method comprising:
after receiving the request message, receiving from the first network node a handover message
triggering a handover of a UE from a cell of the first network node to another cell of the second network node,
wherein
the handover message comprises the first group ID.
33. The method of any one of claims 20-31, wherein
the reporting message comprises a first instance of performance result obtained at a first timing for a first
UE and a series ID identifying the first UE;
the method comprises transmitting towards the first network node a second reporting message which
comprises a second instance of performance result obtained at a second timing for the first UE and the series ID
identifying the first UE; and
the second timing is later than the first timing.
34. The method of any one of claims 20-33, wherein an ML model is trained based on the first UE related
information.
35. The method of claim 28, wherein the priority information indicates a priority level of a UE for which the
first UE related information is requested and/or a priority level of an information type requested in the request
message.
36. The method of claim 35, wherein the priority level of the UE is determined based on (i) whether the
UE is associated with any one or more of a certain network slice, a certain service, or a certain QoS attribute, (ii)
radio capability of the UE, and/or (iii) information about radio access technology that the UE supports.
37. The method of claim 35, wherein
the first UE related information corresponds to a first information type and a second information type, and
the priority information indicates that a priority level of the first information type is higher than a priority
level of the second information type.
38. The method of any one of claims 35-37, wherein the request message indicates how to report UE
related information for the UE having the priority level and/or how to report UE related information corresponding
to the information type having the priority level.
39. A computer program (500) comprising instructions (544) which when executed by processing circuitry
(502) cause the processing circuitry to perform the method of any one of claims 1-38.
40. A carrier containing the computer program of claim 39, wherein the carrier is one of an electronic
signal, an optical signal, a radio signal, and a computer readable storage medium.
41. A first network node (102), the first network node being configured to:
transmit (s402) towards a second network node a request message for requesting first user equipment,
UE, related information, wherein the request message includes a first group UE identifier, ID, identifying a first
group of one or more UEs for which the first UE related information is requested; and
after transmitting the request message, receive (s404) a reporting message which includes first UE
related information for one or more UEs included in the first group of UEs, wherein
the reporting message includes one or more performance measurement results and one or more series
IDs each of which identifies a UE associated with each of the one or more measurement results, and the reporting
message was transmitted by the second network node.
42. The first network node of claim 41, wherein the first network node is configured to perform the
method of any one of claims 2-19.
43. A second network node (104), the second network node being configured to:
receive (s452) from a first network node (102) a request message for requesting first user equipment,
UE, related information, wherein the request message includes a first group UE identifier, ID, identifying a first
group of one or more UEs for which the first UE related information is requested; and
after receiving the request message, transmit (s454) toward the first network node a reporting message
which includes first UE related information for one or more UEs included in the first group of UEs, wherein
the reporting message includes one or more performance measurement results and one or more series
IDs each of which identifies a UE associated with each of the one or more measurement results.
44. The second network node of claim 44, wherein the second network node is configured to perform the
method of any one of claims 21-38.
45. An apparatus (500) comprising:
a processing circuitry (502); and
a memory (541), said memory containing instructions executable by said processing circuitry, whereby the
apparatus is operative to perform the method of any one of claims 1-38.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network node, the method comprising:
transmitting towards a second network node a request message for requesting first user equipment (UE) related information, wherein the request message includes a first group UE identifier (ID) identifying a first group of one or more UEs for which the first UE related information is requested; and
after transmitting the request message, receiving a reporting message, transmitted by the second network node, which includes first UE related information for one or more UEs included in the first group of UEs, wherein
the reporting message includes one or more performance measurement results and one or more series IDs, each of which identifies a UE associated with each of the one or more measurement results.

2. The method of claim 1, wherein the method further comprises:
grouping one or more UEs into the first group of UEs based on a first grouping criteria.

3. (canceled)

4. The method of claim 2, wherein the first grouping criteria is related to any one or more of a particular mobility event, a quality of experience, QoE, reference, a connectivity state of a UE, a configuration of a UE, and/or a capability of a UE.

5. The method of claim 4, wherein the first grouping criteria is based:
the particular mobility event triggered by a particular cause; and/or
the particular mobility event i) occurred during a given duration, ii) started at or after a given start time, and/or iii) ended at or after a given end time.

6. (canceled)

7. The method of claim 3, wherein
the particular mobility event is a handover of a UE from a first group of one or more cells to a second group of one or more cells, and
the first grouping criteria is based on any one or more of:
i) a target frequency carrier of the handover;
ii) a frequency carrier serving a UE before the handover;
iii) the first group of one or more cells;
iv) the second group of one or more cells;
v) an indication that the handover occurred before a desired handover timing;
vi) an indication that the handover occurred after a desired handover timing;
vii) one or more tracking areas, TAs, before the handover;
viii) one or more TAs after the handover;
ix) one or more public land mobile networks, PLMNs, before the handover;
x) one or more PLMNs, after the handover;
xi) one or more geographical areas before the handover; and/or
xii) one or more geographical areas after the handover.

8. (canceled)

9. The method of claim 1, wherein the request message indicates any one or more of:
a start timing of reporting first UE related information;
an end timing of reporting first UE related information;
a time duration of reporting first UE related information;
a maximum number of feedback data instances in one reporting message;
a minimum number of feedback data instances in one reporting message;
a recommended number of feedback data instances in one reporting message and/or
priority information related to the UE related information.

10. The method of claim 2, wherein each of the one or more series IDs identifies a UE which satisfies the first grouping criteria.

11. The method of claim 1, wherein the reporting message includes the first group UE identifier.

12. The method of claim 1, the method further comprising:
after transmitting the request message, transmitting towards the second network node a handover message triggering a handover of a UE from a cell of the first network node to another cell of the second network node, wherein
the handover message comprises the first group ID.

13. The method of claim 1, wherein
the reporting message comprises a first instance of performance result obtained at a first timing for a first UE and a series ID identifying the first UE;
the method comprises receiving a second reporting message which comprises a second instance of performance result obtained at a second timing for the first UE and the series ID identifying the first UE; and
the second timing is later than the first timing.

14. (canceled)

15. The method of claim 9, wherein
the priority information indicates a priority level of a UE for which the first UE related information is requested, and/or
the priority information indicates a priority level of an information type requested in the request message.

16. A method performed by a second network node, the method comprising:
receiving from a first network node a request message for requesting first user equipment (UE) related information, wherein the request message includes a first group UE identifier (ID) identifying a first group of one or more UEs for which the first UE related information is requested; and
after receiving the request message, transmitting towards the first network node a reporting message which includes first UE related information for one or more UEs included in the first group of UEs, wherein
the reporting message includes one or more performance measurement results and one or more series IDs each of which identifies a UE associated with each of the one or more measurement results.

17. The method of claim 16, wherein at least a first UE is grouped into the first group of UEs based on a first grouping criteria.

18. (canceled)

19. The method of claim 17, wherein the first grouping criteria is related to any one or more of a particular mobility event, a quality of experience, QoE, reference, a connectivity state of a UE, a configuration of a UE, and/or a capability of a UE.

20. The method of claim 19, wherein the first grouping criteria is based on:
the particular mobility event triggered by a particular cause; and/or
the particular mobility event i) occurred during a given duration, ii) started at or after a given start time, and/or iii) ended at or after a given end time.

21. (canceled)

22. The method of claim 16, wherein
the particular mobility event is a handover of a UE from a first group of one or more cells to a second group of one or more cells, and
the first grouping criteria is based on any one or more of:
i) a target frequency carrier of the handover;
ii) a frequency carrier serving a UE before the handover;
iii) the first group of one or more cells;
iv) the second group of one or more cells;
v) an indication that the handover occurred before a desired handover timing;
vi) an indication that the handover occurred after a desired handover timing;
vii) one or more tracking areas, TAs, before the handover;
viii) one or more TAs after the handover;
ix) one or more public land mobile networks, PLMNs, before the handover;
x) one or more PLMNs, after the handover;
xi) one or more geographical areas before the handover; and/or
xii) one or more geographical areas after the handover.

23. (canceled)

24. The method of claim 16, wherein the request message indicates:
a start timing of reporting first UE related information;
an end timing of reporting first UE related information;
a time duration of reporting first UE related information;
a maximum number of feedback data instances in one reporting message;
a minimum number of feedback data instances in one reporting message;
a recommended number of feedback data instances in one reporting message; and/or
priority information related to the UE related information.

25. (canceled)

26. The method of claim 16, wherein the reporting message includes the first group UE identifier.

27-30. (canceled)

31. A first network node, the first network node being configured to:
transmit towards a second network node a request message for requesting first user equipment (UE) related information, wherein the request message includes a first group UE identifier (ID) identifying a first group of one or more UEs for which the first UE related information is requested; and
after transmitting the request message, receive a reporting message which includes first UE related information for one or more UEs included in the first group of UEs, wherein
the reporting message includes one or more performance measurement results and one or more series IDs each of which identifies a UE associated with each of the one or more measurement results, and the reporting message was transmitted by the second network node.

32. (canceled)

33. A second network node, the second network node being configured to:
receive from a first network node a request message for requesting first user equipment (UE) related information, wherein the request message includes a first group UE identifier (ID) identifying a first group of one or more UEs for which the first UE related information is requested; and
after receiving the request message, transmit toward the first network node a reporting message which includes first UE related information for one or more UEs included in the first group of UEs, wherein
the reporting message includes one or more performance measurement results and one or more series IDs each of which identifies a UE associated with each of the one or more measurement results.

34. (canceled)
